(19) United States
(12) Patent Application Publication
(10) Pub. No.: US 2007/0172751 A1
(43) Pub. Date: Jul. 26, 2007

(54) Toner for developing electrostatic latent image

(75) Inventor: Hiroto Kidokoro, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: ZEON CORPORATION, Tokyo (JP)

(21) Appl. No.: 10/590,027

(22) PCT Filed: Feb. 23, 2005
(86) PCT No.: PCT/JP05/02859

§ 371 Date: Aug. 18, 2006

(30) Foreign Application Priority Data
Feb. 27, 2004 (JP) 2004-052966

(51) Int. Cl. G03G 9/08; G03G 9/087

(52) U.S. Cl. 430/108.4; 430/111.4; 430/110.3; 430/108.1; 430/109.3; 430/108.7

(57) ABSTRACT

A toner for developing electrostatic latent images comprising a colored resin particle containing a binder resin, a colorant, a charge control agent and a parting agent, has the following properties: (1) the colored resin particle has a volume average particle diameter (Dv) in the range of 4 to 9 μm; (2) the colored resin particle has an average circularity in the range of 0.93 to 0.995; (3) a share viscosity (η1) at a temperature of 130° and a shear rate of 10/s is 3,500 to 8,000 Pa·s; (4) a share viscosity (η2) at a temperature of 130° and a shear rate of 500/s is 300 to 1,300 Pa·s; and (5) a content A of a component having a volatilization temperature of 130° C. or lower is 100 ppm or smaller; (6) a content B of a component having a volatilization temperature of higher than 130° C. to 180° C. is 100 ppm or smaller; (7) a total of the content A and the content B is 150 ppm or smaller; and (8) a ratio of the content A to the content B is 1.0 or smaller. The toner has excellent hot-offset resistance and environmental durability and can be form an image with a stable image density.

### TECHNICAL FIELD

The present invention relates to a toner for developing electrostatic latent images, and in particular, to a toner for developing electrostatic latent images, which has excellent hot-offset resistance and environmental durability and can form an image with a stable image density.

### BACKGROUND ART

Various types of image forming methods using an electrophotographic technology have been widely known. In this technology, a photoconductive member made of a photoconductive material is charged by various methods using a charging device and then the surface of the charged photoconductive member is illuminated with an optical illuminator to form an electrostatic latent image thereon. Then, the electrostatic latent image is developed with a toner for forming a visible image. And, after transferring the visible toner image onto a transfer medium such as paper or OHP film, the transferred toner image is fixed to the transfer medium by any of various methods such as heating and pressing thereby to obtain a print.

Conventionally, a toner requires to have excellent image-reproducibility (thin lines and fine points can be accurately reproduced at developing), low-temperature fixability, hot-offset resistance (a toner does not remain on a hot pressing roller, that is a fixing roller, without transferring to a transfer medium) and the like.

Today, an image forming apparatus tends to be used under high temperature and high humidity areas. Accordingly, in addition to satisfying the aforesaid requirements, it comes to be necessary for a toner for developing electrostatic latent images to have excellent shelf stability and environmental durability and to be able to form an image with a stable image density.

In such the image forming apparatus, a pulverized toner has been mainly employed. The pulverized toner is produced in such a manner that a thermoplastic resin including a colorant, a parting agent, a charge control agent and the like is melt-blended to be uniformly dispersed, the dispersion is pulverized using a pulverizing mill and then the obtained pulverized product is classified using a classifying apparatus.

However, in the pulverized toner, since the parting agent and the charge control resin dispersed in the binder resin are exposed on the surface of the toner, the melted toner is easily adhered to a surface of a high-temperature pressing roll (a hot-pressing roller for fixing a toner). In other words, hot-offset easily occurs. In addition, the pulverized toner has a problem of decreasing in storage ability and environmental durability. Besides, because of its irregular shape, a charge amount of the toner easily fluctuated, resulting in decreasing an image reproducibility.

In order to solve such the problems, a toner (a polymerized toner) producing method by various types of polymerization methods including a suspension polymerization method have been proposed. For instance, in the suspension polymerization method, a polymerizable monomer, a colorant and a polymerization initiator, and, if necessary, a crosslinkable agent, a charge control agent and other additives are uniformly dissolved or dispersed to form a monomer composition and then the monomer composition is polymerized to obtain a toner having a desired particle diameter. By producing a toner by the polymerization method, a particle having a relatively narrow particle diameter distribution can be obtained and a parting agent and a charge control agent can be enveloped within the toner thereby to obtain a toner which can be charged with an uniform charge amount. In addition, a parting agent which melts at low temperatures can be also enveloped within the toner thereby to improve hot-offset resistance.

For such a polymerized toner, Patent Literature 1 discloses a toner which is designed such that was components are dispersed in a binder resin in a granular form and resin components are dispersed in the wax component in a granular form upon observation of the toner in its cross section using a transmission electron microscope. In addition, the toner is designed such that a content of residual monomer contained in the toner is set to a specific range. The patent Literature 1 shows that the toner has excellent low-temperature fixability, shelf stability and durability.

However, the toner disclosed in the literature has a problem in stability of an image density and environmental durability. In addition, it is desired for the toner to further improve the low-temperature fixability.

Patent Literature 2 discloses a toner containing a natural gas based Fischer-Tropsch wax in which an endothermic peak temperature measured by means of a differential scanning calorimeter and an volume average particle diameter are designed to set to specific ranges respectively. The toner disclosed in the Patent Literature 2 has a low fixing temperature, but a high hot-offset temperature. And, the toner has excellent flowability and storage ability. However, the toner disclosed in the literature has a problem in stability of an image density and environmental durability. In addition, it is desired for the toner to further improve the low-temperature fixability.

Patent Literature 3 discloses a toner producing method for containing a charge control resin compound containing a charge control resin, a colorant and an inorganic particle in a binder resin. Use of the toner disclosed in the literature can form an image with a clear tone and provide stable charging ability and excellent fixability. However, it is required for the toner disclosed in Patent Literature 3 to be improved in environmental durability.

Published Patent literature 1: Japanese Patent Application Laid-open Hei 11-249334,

Published Patent literature 2: Japanese Patent Application Laid-open 2002-229251,

Published Patent literature 3: Japanese Patent Application Laid-open 2003-131428.

### DISCLOSURE OF THE INVENTION

### Problems to be Resolved by the Invention

Accordingly, the object of the present invention is to provide a toner for developing electrostatic latent image, which has excellent hot-offset resistance and environmental durability and can be form an image with a stable image density.

The inventor of the present invention carried out an in-depth study to accomplish the object. As a result, he has found this object can be accomplished by using a toner for developing electrostatic latent images comprising a colored resin particle containing at least a binder resin, a colorant, a charge control agent and a parting agent, in which the colored resin particle is designed such that a volume average particle diameter and an average circularity are set to a specific range respectively, a shear viscosity at a specific share rate is set to a specific range and also a content of a component having a specific volatilization temperature is set to a specific range.

The present invention has been accomplished based on the above finding and provide a toner for developing electrostatic latent images comprising a colored resin particle containing a binder resin, a colorant, a charge control agent and a parting agent, having the following properties: (1) said colored resin particle has a volume average particle diameter (Dv) in the range of 4 to 9 μm; (2) said colored resin particle has an average circularity in the range of 0.93 to 0.995; (3) said toner has a share viscosity (η1) at a temperature of 130° and a shear rate of 10/s in the range of 3,500 to 8,000 Pa·s; (4) said toner has a share viscosity (η2) at a temperature of 130° and a shear rate of 500/s in the range of 300 to 1,300 Pa·s; (5) said toner has a content A of a component having a volatilization temperature of 130° C. or lower of 100 ppm or smaller; (6) said toner has a content B of a component having a volatilization temperature of higher than 130° C. to 180° C. of 100 ppm or smaller; (7) said toner has a total of the content A and the content B of 150 ppm or smaller; and (8) said toner has a ratio of the content A to the content B of 1.0 or smaller.

### EFFECT OF THE INVENTION

According to the present invention, a toner for developing electrostatic latent images, which has excellent hot-offset resistance and environmental durability and can form an image with a stable image density, can be provided.

### BEST MODE FOR CARRYING OUT THE INVENTION

A toner for developing electrostatic latent images according to the present invention is described below.

A toner for developing electrostatic latent images according to the present invention comprises a colored resin particle containing at least a binder resin, a colorant, a charge control agent and a parting agent.

As the examples of the binder resin, there can be mentioned; resins such as polystyrene, styrene-butyl acrylate copolymers, polyester resins and epoxy resins, which are conventionally used for the toner.

For a black-and-white toner (a black color toner), any pigments and dyes can be employed, in addition to carbon black, titanium black, magnetic powder, oil black and titanium white. Carbon black having a primary particle diameter in the range of 20 to 40 nm is preferably used as a black colorant. The particle diameter within this range is preferred because such carbon black can be uniformly dispersed in the toner and fog in printed image developed using the resulting toner decreases.

For a full color toner (a yellow color toner, a magenta color toner and a cyan color toner), a yellow colorant, a magenta colorant and a cyan colorant, respectively, are generally used.

As the yellow colorant, there can be mentioned; compounds such as azo pigments, and condensed polycyclic pigments. Specific examples of the yellow colorant include pigments such as C.I. Pigment Yellow 3, 12, 13, 14, 15, 17, 62, 65, 73, 74, 83, 90, 93, 97, 120, 138, 155, 180, 181, 185 and 186.

As the magenta colorant, there can be mentioned; compounds such as azo pigments, and condensed polycyclic pigments. Specific examples of the magenta colorant include pigments such as C.I. Pigment Red 31, 48, 57, 58, 60, 63, 64, 68, 81, 83, 87, 88, 89, 90, 112, 114, 122, 123, 144, 146, 149, 150, 163, 170, 184, 185, 187, 202, 206, 207, 209, 251, and C.I. Pigment Violet 19.

As the cyan colorant, there can be mentioned; cupper phthalocyanine compounds and their derivatives, anthraquinone compounds and the like. Specific examples of the cyan colorant include pigments such as C. I. Pigment Blue 2, 3, 6, 15, 15:1, 15:2, 15:3, 15:4, 16, 17, and 60.

One or two or more kinds of each of the yellow colorant, the magenta colorant and the cyan colorant may be used together.

An amount of the colorant is preferably 1 to 10 parts by weight per 100 parts by weight of the binder resin.

As the charge control agent, charge control agents used in conventionally used toners can be employed without limitation. Among the charge control agents, a charge control resin is preferable, because charge control resins have high compatibility with binder resins, are colorless, and can provide a toner with a stable charging property even when it is used in high-speed continuous color printing. As the positive charge control resin, there can be mentioned; quaternary ammonium (salt) group-containing copolymers produced in accordance with the descriptions of U.S. Pat. No. 4,840,863 (A), Japanese Patent Application Laid-Open Nos. Hei 3-175456, Hei 3-243954 and Hei11-15192. And, as the negative charge control resin, there can be mentioned; sulfonic acid (salt) group-containing copolymers produced in accordance with the descriptions of U.S. Pat. No. 4,950,575(A) and Japanese Patent Application Laid-Open No. Hei 3-15858.

An amount of the monomer unit having the quaternary ammonium (salt) group or the sulfonic acid (salt) group contained in these copolymers is preferably 1 to 12% by weight, more preferably 1.5 to 8% by weight, to an amount of the charge control resin. If the amount of the monomer unit is within this range, a charge amount of the toner for developing electrostatic latent images is easy to control, whereby the generation of fog in printed image developed using the toner can be minimized.

Preferred as the charge control resin is that having a weight average molecular weight of 2,000 to 50,000, more preferably 4,000 to 40,000, most preferably 6,000 to 35,000. If the charge control agent has a weight average molecular within the aforesaid range, occurrence of hot-offset and decrease in fixability may be suppressed.

A glass transition temperature of the charge control resin is preferably from 40 to 80° C., more preferably from 45 to 75° C., most preferably from 45 to 70° C. If the charge control resin has a glass transition temperature within this range, both of a shelf stability and a fixability may be improved in a balanced manner.

An amount of the charge control agent is generally 0.1 to 10 parts by weight, preferably 0.5 to 6 parts, per 100 parts by weight of the binder resin.

As the parting agent, there can be mentioned; polyolefin waxes such as low molecular weight polyethylene, low molecular weight polypropylene and low molecular weight polybutylene; natural plant waxes such as candelilla, carnauba, rice, wood wax and jojoba; petroleum waxes such as paraffin, microcrystalline and petrolatum, as well as waxes modified therefrom; synthetic waxes such as Fischer-Tropsch wax; and multifunctional ester compounds such as pentaerythritol tetrastearate, pentaerythritol tetrapalmitate, dipentaerythritol hexamyristate and pentaerythritol tetramyristate.

Among these parting agents, multifunctional ester compounds are preferred. Furthermore, multifunctional ester compounds are more preferred, which show an endothermic peak temperature within the range preferably from 30 to 150° C., more preferably from 40 to 100° C., most preferably from 50 to 80° C., measured with a DSC curve by means of a differential scanning calorimeter at rising temperature, because a toner excellent in a balance between fixing property and peeling property during fixing is obtained. In particular, those having a molecular weight of 1,000 or more and soluble in styrene at 25° C. in an amount of 5 parts by weight or more per 100 parts by weight of styrene, and having an acid value of 1 mg KOH/g or less and a hydroxy value of 5 mg KOH/g or less, are even more preferred, because it exhibits an effect in lowering a fixing temperature and suppressing occurrence of hot-offset. The acid value and the hydroxyl value refer to values measured in accordance with JOCS.2.3.1-96 and JOCS.2.3.6.2-96, respectively, which are standards of an oil analysis method established by JAPAN Oil Chemists' Society (JOCS). As the multifunctional eater compound, dipentaerythritol hexamyristate and pentaerythritol tetramyristate are specifically preferred. The endothermic peak temperature refers to values measured in accordance with ASTM D3418-82.

An amount of the parting agent is generally 3 to 20 parts by weight, preferably 5 to 15 parts by weight, per 100 parts by weight of the binder resin.

The colored resin particle may be a so-called core-shell structured (also called “capsule type”) particle, in which a polymer for an inner layer (an core layer) of the particle is different from a binder resin for an outer layer (a shell layer) of the particle. The core-shell structure is preferred because the type can provide a favorable balance between lowering of the fixing temperature and prevention of aggregation of the toner during storage by covering the low softening point substance as the inner layer (core layer) with a substance having a higher softening point.

The core layer of the core-shell type particle is composed of the aforementioned binder resin, colorant, charge control resin and parting agent, while the shell layer is composed of the binder resin alone.

A proportion by weight of the core layer to the shell layer of the core-shell type particle is not particularly limited, but is generally in the range of 80/20 to 99.9/0.1.

By using the shell layer in this proportion, good shelf stability and good low temperature fixability of the toner can be fulfilled at the same time.

An average thickness of the shell layer of the core-shell type particle may be generally 0.001 to 0.1 μm, preferably 0.003 to 0.08 μm, more preferably 0.005 to 0.05 μm. The toner having a thickness within the range is preferred because fixability and storage ability thereof are improved. The colored resin particle of the core-shell type particle does not necessarily have entire of its surface covered with the shell layer. The surface of the core particle may partly be covered with the shell layer.

A diameter of the core particle and a thickness of the shell layer of the core-shell type particle can be measured by directly measuring the diameter and thickness of particles which are chosen randomly from photographs taken with an electron microscope, if possible. When it is difficult to observe both of the core and shell layer by an electron microscope, they can be calculated based on the diameter of the core particle and the amount of the monomer used for forming the shell layer at the time of producing the toner.

The colored resin particle constituting a toner for developing electrostatic latent images according to the present invention has preferably a volume average particle diameter (Dv) in the range of 4 to 9 μm, more preferably 4 to 7 μm. If the Dv may be smaller than 4 μm, flowability of the resulting toner for developing electrostatic latent images may lower, resulting in causing fog and decreasing dot reproducibility. On the contrary, if the Dv may be larger than 9 μm, tine-lines reproducibility may be lowered.

The colored resin particles constituting a toner for developing electrostatic latent images according to the present invention preferably has a ratio (Dv/Dp) of the volume average particle diameter (Dv) to a number average particle diameter (Dp) in the range of 1.0 to 1.3, preferably 1.0 to 1.2. If the Dv/Dp may be within this range, occurrence of fog may be suppressed.

The colored resin particle constituting the toner for developing electrostatic latent images according to the present invention has an average circularity, as measured by a flow particle image analyzer, in the range of 0.93 to 0.995, preferably 0.95 to 0.995. The circularity within this range suppresses lowering of thin-lines reproducibility at any environments of a L/L environment (a temperature: 10° C., a humidity: 20%), a N/N environment (a temperature: 23° C., a humidity: 50%) and a H/H environment (a temperature: 35° C., a humidity: 80%).

Producing a toner for developing electrostatic latent images by means of a phase-transfer emulsion process, a solution suspension process, or a polymerization process (suspension polymerization process and emulsion polymerization method) and the like makes it possible to set the average circularity to the range easily.

In the present invention, the circularity is defined as a ratio of a perimeter of a circle having the same projected area as that of the particle image to a perimeter of the projected area of the particle. And, the circularity in the present invention is used as a conventional method for quantitatively presenting a shape of a particle, and is an index for showing a degree of surface roughness of the colored resin particle. If the colored resin particles are perfectly spherical, the circularity equals to 1. And, the larger the roughness of the colored resin particle is, the smaller the circularity is. The average circularity (Ca) is calculated using the following formula.

$$Ca = ( {\sum }_{i = 1}^{n} ( Ci \times f i ) ) / {\sum }_{i = 1}^{n} ( f i )$$

In the above formula, n represents the number of particles used for calculating the circularity Ci.

In the above formula, Ci represents the circularity of each particle in a group of particles having a circle equivalent diameter of 0.6 to 400 μm, which is calculated by the following formula from the measured circuit length of each particle.

Circularity (Cᵢ)=a perimeter length of a circle having the same area as a projected area of a particle/a perimeter length of the projected area of the particle.

In the above formula, fᵢ represent a frequency of particle having circularity Cᵢ.

The number average particle diameter, the volume average particle diameter, the circularity and the average circularity of the colored resin particle may be measured with a flow particle projection image analyzer, such as FPIA-2100 (trade name) or FPIA-2000 (trade name), manufactured by Sysmex Corporation.

The toner for developing electrostatic latent images according to the present invention has a shear viscosity (η1) in the range of 3,500 to 8,000 Pa·s, preferably 4,000 to 7,000 Pa·s, at a temperature of 130° C. and a shear rate of 10/s. If η1 may be smaller than 800 Pa·s, hot-offset may occur easily and a storage ability may deteriorate. On the contrary, if η1 may be larger than 4,000 Pa·s, a low-temperature fixability may decrease.

And, the toner for developing electrostatic latent images according to the present invention has a shear viscosity (η92) in the range of 300 to 1,300 Pa·s, preferably 400 to 1,000 Pa·s, at a temperature of 130° C. and a shear rate of 500/s. If η2 may be smaller than 300 Pa·s, hot-offset may occur easily and a storage ability may deteriorate. On the contrary, if η1 may be larger than 1,300 Pa·s, a low-temperature fixability may decrease.

Besides, the toner for developing electrostatic latent images according to the present invention preferably has a ratio (η1/η2) of η1 to η2 in the range of 3 to 10, more preferably 5 to 10.

The toner having η1/η2 within the aforesaid range is preferred because decreasing of a low-temperature fixability and occurrence of hot-offset are suppressed.

The shear viscosity can be measured using a capillary rheometer in accordance with JISK7199. Using a twin capillary rheometer of the capillary rheometer is preferable because a shear viscosity can be measured easily. A conventionally used capillary rheometer is equipped with a long capillary die. However, since such the capillary rheometer causes pressure loss at measurement, it is necessary to compensate for the loss. Therefore, in order to obtain correct rheologic properties of a substance, a measurement using a capillary rheometer equipped with a short capillary die under the same condition is required. Using a twin capillary rheometer enables the measurements at once. As such a twin capillary rheometer, “RH7” (trade name) manufactured by ROSAND and the like can be employed.

In the toner for developing electrostatic latent images according to the present invention, a content A of a component having a volatilization temperature of 130° C. or lower is 100 ppm or smaller, preferably 80 ppm or smaller, more preferably 50 ppm or smaller. And, in the toner for developing electrostatic latent images according to the present invention, a content B of a component having a volatilization temperature of higher than 130° C. to 180° C. is 100 ppm or smaller, preferably 80 ppm or smaller, more preferably 50 ppm or smaller.

If the content A of a component having a volatilization temperature of 130° C. or lower may exceed 100 ppm, an image density of a printed image formed using the resultant toner may be lowered, environmental durability of the toner may be decreased and fog may occur on the printed image. And, if the content B of a component having a volatilization temperature of higher than 130° C. to 180° C. may exceed 100 ppm, hot-offset may occur.

And, a total of the content A and the content B is 150 ppm or smaller, preferably 100 ppm or smaller. And, a ratio of the content A to the content B is 1.0 or smaller, preferably 0.8 or smaller.

If the total of the content A and the content B may exceed 150 ppm, an image density of a printed image formed using the resultant toner may be lowered, environmental durability of the toner may be decreased and fog may occur on the printed image. And, if the ratio of the content A to the content B may be out of the aforesaid range, an image density of a printed image formed using the resultant toner may be lowered, environmental durability of the toner may be decreased and fog may occur on the printed image.

In the present invention, the component having a volatilization temperature of 130° C. or lower and the component having a volatilization temperature of higher than 130° C. to 180° C. are components, not including water, which are volatilized at each temperature such that a toner for developing electrostatic latent images is heated at 130° C. for 30 minutes and then heated at 180° C. for 30 minutes. All of substances satisfying the above condition are included. As such substances, for instance, macromonomer unreacted residual, monomer (monovynil monomer, crosslinkable monomer and the like) component, residual reaction solvent, impurities in colorant, impurities in charge control resin, impurities in external additive and decomposition product of polymerization initiator and the like are given.

Heretofore, as to volatile components of a toner, a residual monomer is provided; however, in addition to the residual monomer, hard-volatile components and substances which are decomposed and volatilized at high temperatures may be included. Remaining of hard-volatile components and the like may exert a bad influence on a printed image quality well as a fixability. Generally, a monomer component has a volatilization temperature of 130° C. or lower while a fixing roll is heated 180 to 200° C. at fixing a toner. Accordingly, it is necessary that an amount of residual of a polymerization initiator and residual of a molecular weight modifier, in addition to the monomer component, are small.

In the present invention, a volatilized component is determined in the following manner. For example, a toner for developing electrostatic latent images is heated at 130° C. for 30 minutes and then at 180° C. for 30 minutes and then a component volatilized at each heating temperature is determined using a purge & trap (P&T)/gas chromatography. Usually, a volatilized component is determined using a headspace/gas chromatography; however, a P&T/gas chromatography method is preferred from a viewpoint of precision. However, not to the method, other methods capable of determining a volatilized component may be employed. A qualitative analysis of a volatilized component can be carried out using a mass spectroscopy/gas chromatography (MS/GC) and the like.

In the toner for developing electrostatic latent images according to the present invention, an amount of insoluble component in tetrahydrofran is preferably 50 to 95% by weight, more preferably 50 to 90% by weight. An amount of insoluble component in tetrahydrofran within the range is preferred because occurrence of hot-offset may be suppressed and shelf stability of the toner may be improved.

The amount of insoluble component in tetrahydrofran can be measured using an after-mentioned method.

For the toner for developing electrostatic latent images according to the present invention, the toner can be used, as it is, for development in electrophotography. Generally, however, it is preferable that the toner is used after fine particles having a smaller particle diameter than that of the colored resin particles (the fine particles will be referred to hereinafter as an external additive) are adhered to or buried into the surfaces of the colored resin particles, in order to adjust the charging property, flowability and shelf stability of the toner.

Examples of the external additive are inorganic particles and organic resin particles which are used for improving flowability and charging property. The particles added as the external additive has an average particle diameter smaller than the colored resin particle. Specific examples of the inorganic particles include silica, aluminum oxide, titanium oxide, zinc oxide, tin oxide and the like. Specific examples of the organic resin particles include methacrylic ester polymer particles, acrylic ester polymer particles, styrene-methacrylic ester copolymer particles, styrene-acrylic ester copolymer particles, core-shell structured particles having a core formed of a styrene polymer and a shell formed of a methacrylic ester polymer. Of these particles, particles of silica and titanium oxide are preferred. In addition, a hydrophobicitizing-treated particles are preferred. In fact, a hydrophobicitizing-treated silica is more preferred. An amount of the external additive is not limited; however, is generally 0.1 to 6 parts by weight per 100 parts by weight of the colored resin particle.

The colored resin particle constituting a toner for developing electrostatic latent images according to the present invention may be produced by any methods for producing a toner having the aforesaid properties; however, not limited to, the colored resin particle is preferably produced by a polymerization method, especially a suspension polymerization method.

Next, a method for producing a colored resin particle constituting a toner for developing electrostatic latent images by the polymerization method will be described.

The colored resin particle constituting a toner for developing electrostatic latent images according to the present invention is produced, for instance, such that a colorant, a charge control agent, a parting agent, a chain transfer agent and other additives are dissolved or dispersed in a polymerizable monomer which is a raw material of a binder resin, the mixture to which a polymerization initiator is added is polymerized in an aqueous dispersion medium containing a dispersion stabilizer and then the resultant product is subjected to a filtration, washing, dehydration and drying. At the polymerization, a kind and an amount ratio of the polymerizable monomer, a kind and an amount of the crosslinkable monomer, an amount of the chain transfer agent, a kind and an amount of the parting agent and a kind and an amount of the polymerization initiator are controlled so that shear viscosities η1 and η2, the volatile contents A and B and the like can be set to the specified ranges.

Alternatively, the colored resin particle constituting a toner for developing electrostatic latent images according to the present invention is obtained in the following manner. A polymerizable monomer which is a raw material of a binder resin, a chain transfer agent and other additives are emulsion polymerized in an aqueous dispersion medium containing a emulsifying agent and then a colorant, a charge control agent and a parting agent are emulsified. And, the emulsified components are aggregated by heat to prepare a dispersion of the colored resin particles. Then, the dispersion of the colored resin particles is subjected to a filtration, washing, dehydration and drying. At the polymerization, a kind and an amount ratio of each of the polymerizable monomer and the crosslinkable monomer, an amount of the chain transfer agent, a kind and an amount of the parting agent and a kind and an amount of the polymerization initiator are controlled so that shear viscosities η1 and η2, the volatile contents A and B like can be set to the specified ranges.

As a polymerizable monomer, there can be mentioned, for instance, a monovinyl monomer, a crosslinkable monomer and a macromonomer. These polymerizable monomers become the binder resin component after polymerization.

Specific examples of the monovinyl monomers include; aromatic vinyl monomers such as styrene, vinyltoluene and α-methylstyrene; acrylic ester monomers such as acrylic acid, methyl acrylate, ethyl acrylate, propyl acrylate, butyl acrulate, 2-ethylhexyl acrylate, cyclohexyl acrylate and isobonyl acrylylate; methacrylic ester monomers such as methacrylic acid, methyl methacrylate, ethyl methacrylate, propyl methacrylate, butyl methacrylate, 2-ethlhexyl methacrylate, cyclohexyl methacrylate and isobonyl methacrylylate; and mono olefin monomers such as ethylene, propylene and butylenes; and the like.

The monovinyl monomers may be used alone or in a combination thereof. Among the monovinyl monomers as mentioned above, it is preferable to use aromatic vinyl monomers alone, or to use aromatic vinyl monomers in a combination with acrylic ester monomers or methacrylic ester monomers.

The use of the crosslinkable monomer in a combination with the monovinyl monomer effectively improves hot offset resistance of the resulting toner. The crosslinkable monomer is a monomer having two or more vinyl groups. As specific examples of the crosslinkable monomer, there can be mentioned; divinylbenzene, divinylnaphthalene, ethlenglycol dimethacrylate, pentaerythritol triallyl ether and trimethylolpropane triacrylate. These crosslinkable monomers may be used alone or in a combination thereof. An amount of the crosslinkable monomer is generally 10 parts by weight or less, preferably 0.1 to 2 parts by weight, per 100 parts by weight of the monovinyl monomer.

It is preferable to use a macromonomer together with the monovinyl monomer because this use provides a satisfactory balance between shelf stability and fixability at a low temperature. The macromonomer is an oligomer or polymer having a polymerizable carbon-carbon unsaturated double bond at its molecular chain terminal and a number average molecular weight of generally from 1,000 to 30,000.

The macromonomer is preferably the one which gives a polymer having a glass transition temperature higher than that of a polymer obtained by polymerizing the above-mentioned monovinyl monomer alone.

An amount of the macromonomer used is generally 0.01 to 10 parts by weight, preferably 0.03 to 5 parts by weight, more preferably 0.05 to 1 part by weight, per 100 parts by weight of the monovinyl monomer.

As examples of the polymerization initiator, there can be mentioned; persulfates such as potassium persulfate and ammonium persulfate; azo compounds such as 4,4′-azobis-(4-cyanovaleric acid), 2,2′-azobis-(2-methyl-N-(2-hydroxyethyl))propionamide, 2,2′-azobis-(2-amidinopropane)dihydrochloride, 2,2′-azobis-(2,4-dimethyl valeronitrile) and 2,2′-azobis-isobutyronitrile; and peroxides such as di-t-butyl peroxide, benzoyl peroxide, t-butyl peroxy-2-ethylhexanoate, t-hexyl peroxy-2-ethylhexanoate, t-butyl peroxypivalate, di-isopropyl peroxydicarbonate, di-t-butyl peroxyisophthalate, and t-butyl peroxyisobutyrate. Redox initiators, composed of combinations of these polymerization initiators with a reducing agent, may also be used.

An amount of the polymerization initiator used in the polymerization of the polymerizable monomer is preferably 0.1 to 20 parts by weight, more preferably 0.3 to 15 parts by weight, most preferably 0.5 to 10 parts by weight, per 100 parts by weight of the polymerizable monomer. The polymerization initiator may be added to the polymerizable monomer composition in advance or may be added to an aqueous dispersion medium after forming droplets depending on conditions.

Moreover, at the time of polymerization, a dispersion stabilizer may be added to the aqueous dispersion medium. As the dispersion stabilizer, there can be mentioned; an inorganic salt such as barium sulfate, calcium sulfate, calcium carbonate, magnesium carbonate and calcium phosphate; an inorganic oxide such as aluminum oxide and titanium oxide; an inorganic compound such as aluminum hydroxide, magnesium hydroxide and ferric hydroxide; a water-soluble polymers such as polyvinyl alcohol, methyl cellulose and gelatin; anionic surfactants; nonionic surfactants; and amphoteric surfactants. The aforesaid dispersion stabilizers may be used alone or in combination of two kinds thereof.

Among the above dispersion stabilizers, in a suspension polymerization method, a dispersion stabilizer containing colloid of a metallic compound, especially a hardly water-soluble inorganic hydroxide, is preferred, since it can narrow a particle size distribution of a polymer particles; a remaining amount of the dispersion stabilizer after washing is small; and it can sharply reproduce images.

In the present invention, a dispersion stabilizer containing a colloid of hardly water-soluble inorganic hydroxide is preferably prepared in the following manner. For instance, in a procedure in which an aqueous solution (A) of water-soluble polyvalent metal compound and an aqueous solution (B) containing anion for colloid formation are mixed to form an aqueous solution of colloid of hardly water-soluble inorganic hydroxide and a liquid temperature (t) of the aqueous solution is preferably set to 25 to 75° C., more preferably 25 to 45° C., a formation of the colloid is preferably carried out under an inert gas atmosphere. In addition, a liquid temperatures of each of the solution (A) and the solution (B) is preferably t±10° C. Furthermore, it is preferable to add droplets of polymerizable monomer after 4 hours since the dispersion stabilizer containing colloid of hardly water-soluble inorganic hydroxide has been formed.

And, a mixing of the aqueous solution of colloid of hardly water-soluble inorganic hydroxide and the polymerizable monomer composition is preferably performed in such a way that they are dispersed using a stirrer to form a solution of dispersion stabilizer in which the polymerizable monomer composition are dispersed.

Beside, the droplets are preferably formed under an inert gas atmosphere, and a difference in liquid temperature before and after the formation of the droplets is preferably 0 to 20° C.

An amount of the above dispersion stabilizer is preferably 0.1 to 20 parts by weight per 100 parts by weight of the polymerizable monomer. The amount of the dispersion stabilizer within this range is preferred because the polymerization reaction is stably performed and a formation of polymerization aggregate is suppressed.

Further, upon polymerization, a molecular weight modifier is preferably used. As the molecular weight modifier, there can be mentioned; mercaptans such as t-dodecyl mercaptan, n-dodecyl mercaptan, n-octyl mercaptan and 2,2,4,6,6-pentamethylheptane-4-thiol and the like. Among the above ones, 2,2,4,6,6-pentamethylheptane-4-thiol is preferred. The molecular weight modifier may be added before or during polymerization reaction. An amount of the molecular weight modifier is preferably 0.01 to 10 parts by weight, more preferably 0.1 to 5 parts by weight, per 100 parts by weight of the polymerizable monomer.

A method for producing the core-shell type colored resin particles is not limited, and these colored resin particles can be produced by a publicly known method. For example, a method such as spray-drying method, interfacial reaction method, in-situ polymerization method, or phase separation method may be named. Specifically, colored resin particles obtained by pulverization, polymerization, association or phase inversion emulsification as core particles are covered with a shell layer to prepare core-shell type colored resin particles. Of these methods, the in-situ polymerization method and phase-separation method are preferable from the viewpoint of efficient productivity.

The method for producing the core-shell type colored resin particles using the in-situ polymerization process is described below.

A polymerizable monomer to form a shell (a polymerizable monomer for shell) and a polymerization initiator are added to an aqueous dispersion medium including core particles dispersed therein, and the mixture is polymerized to obtain the core-shell type colored resin particles.

As specific examples of the process for forming the shell, there can be mentioned; a process comprising adding a polymerizable monomer for a shell to a reaction system of a polymerization reaction which has been conducted for preparing core particles to continuously conduct polymerization; and a process comprising introducing core particles prepared in a different reaction system and adding a polymerizable monomer for a shell thereto to conduct polymerization.

The polymerizable monomer for shell may be added to the reaction system at one time, or may be added continuously or dividedly using a pump such as a plunger pump.

As the polymerizable monomer for shell, monomers capable of forming a polymer having a glass transition temperature of higher than 80° C. by polymerization, such as styrene, acrylonitrile and methyl methacrylate, may be used alone or in a combination thereof.

When the polymerizable monomer for shell is added to the reaction system, a water-soluble polymerization initiator as a polymerization initiator for polymerizing the polymerizable monomer for shell is preferably added, because this addition makes it easy to obtain the core-shell type colored particles. It is speculated that when the water-soluble polymerization initiator is added during addition of the polymerizable monomer for shell, the water-soluble polymerization initiator migrates to a zone surrounding the surface of the core particle, the zone where the polymerizable monomer for shell has moved, so that a polymer (shell) is easily formable on the surface of the core particle.

As the water-soluble polymerization initiator; there can be mentioned; persulfates such as potassium persulfate, and ammonium persulfate; azo compounds such as 2,2′-azobis-(2-methyl-N-(2-hydroxyethyl)propionamide), and 2,2′-azobis-(2-methyl-N-(1,1-bis(hydroxymethyl)-2-hydroxyethyl)propionamide. An amount of the water-soluble polymerization initiator is generally 0.1 to 30 parts by weight, preferably 1 to 20 parts by weight, per 100 parts by weight of the polymerizable monomer for shell.

A temperature during the polymerization is preferably 50° C. or higher, more preferably 60 to 95° C. A polymerization reaction period is preferably 1 to 20 hours, more preferably 2 to 10 hours. After completion of the polymerization, a procedure comprising filtration, washing, dehydration and drying is preferably repeated several times, as desired, in accordance with the conventional methods.

In the aqueous dispersion of the colored resin particles obtained by the polymerization, if an inorganic compound such as inorganic hydroxide is used as the dispersion stabilizer, the dispersion stabilizer is preferably dissolved in water and removed by adding acid or alkali. If a colloid of a hardly water-soluble inorganic hydroxide is used as the dispersion stabilizer, it is preferable to add acid so that pH of the aqueous dispersion is pH6.5 or lower. As the acid to be added, an inorganic acid such as sulfuric acid, hydrochloric acid or nitric acid; or an organic acid such as formic acid or acetic acid; can be used. Sulfuric acid is particularly preferable because it has a high efficiency of its removal and its burden on production facilities is light.

There is no limitation on the method of filtering the colored resin particle from the aqueous dispersion medium for dehydration. For example, centrifugal filtration, vacuum filtration or pressurized filtration can be named. Of these methods, centrifugal filtration is preferable.

The toner for developing electrostatic latent images according to the present invention is obtained by mixing the colored resin particles and the external additive and, if desired, other fine particles by means of a high-speed stirrer such as a Henschel mixer.

### EXAMPLE

The present invention is hereinafter to be described more specifically by the following examples. Such examples, however, are not to be construed as limiting in any way the scope of the present invention. All designations of “part” or “parts” and “%” used in the following examples mean part or parts by weight and wt. % unless expressly noted.

In this example, a toner for developing electrostatic latent images is evaluated using the following methods.

1. Property of Colored Resin Particle

(1) Volume Average Particle Diameter, Particle Size Distribution and Average Circularity

100 μl of an aqueous solution of 0.1% sodium dodecylbenzenesulfonate (an anion surface activator) as a dispersion medium was added to 20 mg of a toner for developing electrostatic latent images and blended with the toner. And, 10 ml of ion-exchanged water was added to the toner mixture and stirred, and then the toner mixture was dispersed using an ultrasonic dispersion apparatus of 60 W for 30 minutes. A toner concentration at a measurement was adjusted to 3,000 to 10,000/μl and then 1,000 to 10,000 of the toner particle having a circle equivalent diameter of 1 μm or more were evaluated using a flow particle image analyser “FPIA-2100” (trade name), manufactured by Sysmex Corporation. From the measurement, a volume average particle diameter (Dv), a particle diameter distribution, i.e., a ratio (Dv/Dp) of the volume average particle diameter to a number average particle diameter (Dp), and an average circularity were obtained.

(2) Shear Viscosity

A shear viscosity was evaluated in accordance with JIS K7199. A toner for developing electrostatic latent images weighed about 30 g was charged into a barrel and heated to melt the toner for developing electrostatic latent images while degassing and then maintained at 130° C. for 10 minutes. Then, the toner was evaluated by means of a capillary rheometer (RH7, trade name, manufactured by ROSAND) under the following condition. The obtained data was subjected to a correction (Bagley collection) for a pressure loss caused by the capillary die and Rabinovich correction using an analysis software (Dr. Rheology Ver. 7, trade name, manufactured by ITS JAPAN Co., Ltd.) to obtain a graph showing a shear viscosity. From the graph, shear viscosities η1 and η2 at shear rates of 10/s and 500/s, respectively, were obtained.

Measurement Condition:

A diameter of the barrel: 15 mm;

A length of the barrel: 280 mm;

A material of the capillary die: tungsten carbide;

A capillary die: a diameter of 1 mm, a length of 16 mm, an inflow angle of 180° and a diameter of 1 mm, a length of 0 mm, an inflow angle of 180°; and

A measurement mode: twin capiro mode, Bagley correction: ON,

Rabinovich correction: ON.

(3) Amount of Insoluble Component in Tetrahydrofran.

About 1 g of the toner for developing electrostatic latent image was weighed and charged into a Soxhlet extractor equipped with a cylindrical filter (No. 86R, 29×100 mm, manufactured by Toyo Roshi Kaisha, Ltd.). Then, the toner was refluxed with about 100 ml of tetrahydrofuran (THF) as a solvent for 6 hours. The reflux was carried out at a rate in which one droplet of the solvent was dropped every 5 to 15 minutes. After completion of the reflux, the cylindrical filter was air-dried in a draft for one night and further dried under reduced pressure at 50° C. for 1 hour, and then weighed. Then, an amount of insoluble component in tetrahydrofran was measured using the following expression.
An amount of insoluble component in tetrahydrofran (% by weight)=(S/T)×100.

In the expression, T represents an amount (g) of the toner for developing electrostatic latent image and S represents an amount (g) of the insoluble component remaining on the filter after the reflux.

(4) Amount of Volatilized Component

In accordance with a purge&trap/gas chromatography method (a P&T/GC method) described below, a content A of a component having a volatilization temperature of 130° C. or lower and a content B of a component having a volatilization temperature of higher than 130 to 180° C. were obtained.

0.1 g of a toner for developing electrostatic latent images was charged into a purge container and heated at a heating rate of 10° C./minute from room temperature while passing helium gas as a carrier gas in the purge container at a flow rate of 50 ml/minutes, and then maintained at 130° C. for 30 minutes. And, a volatilized component generated by the heating was caught into a trap tube which had been cooled at −130° C. After catching the volatilized component, the purge container was cooled down to room temperature. Then, the trap tube in which the volatilized component was caught was heated at a heating rate of 50° C./minutes to 280° C. from −130° C., and then the volatilized component was determined using a gas chromatography under the following conditions to obtain a content A of a component having a volatilization temperature of 130° C. or lower. Next, the above purge container which was cooled down to room temperature was maintained at 180° C. for 30 minutes and then the volatilized component was determined to obtain a content B of a component having a volatilization temperature of higher than 130 to 180° C.

For the measurement, a gas chromatograph 6890 (trade name, FID method, manufactured by Agilent Technologies), C-R7A chromatopack (trade name, manufactured by Shimadzu Corporation), a purge&trap sampler of TDC (trade name, manufactured by Agilent Technologies) and a column of DB-5 (trade name, manufactured by J&D, L=30 m, I.D=0.32 mm, Film=0.25 μm) were employed.

Measurement Conditions

A temperature of the column: 50° C. (maintained for 2 minutes) to 270° C. (a heating rate of 10° C./minutes),

A sample transfer temperature: 280° C.,

A detection temperature: 280° C.,

A carrier gas: helium gas,

A flow rate: 1 ml/minutes.

Property of Toner

(5) Fixing Temperature

A fixing test was conducted using a commercially available non-magnetic-one-component developing type printer (printing speed: 24 sheet/min machine) modified such that a temperature of its fixing roll portion would be variable. After a temperature of the fixing roll of the modified printer was stabilized at 150° C., the fixing test was performed for obtaining a fixing ratio which is a ratio of an image density after a tape peeling treatment to that before the treatment in a black solid printing area in a test sheet printed by the modified printer. That is, the fixing rate was calculated from the following equation:
Fixing ratio (%)=(ID_{After}/ID_{Before})×100
where ID_{Before} represents the image density before tape peeling treatment, and ID_{After} represents the image density after tape peeling treatment.

The tape peeling treatment means a series of steps consisting: applying an adhesive tape (Scotch Mending Tape 810-3-18, trade name, manufactured by Sumitomo 3M Limited) to a portion of the test sheet to be evaluated, pressing the adhesive tape at a constant pressure, and then peeling the adhesive tape at a constant speed in a direction along the sheet. The image density was measured by use of a Macbeth's reflection type image density measuring device.

(6) Hot-Offset Temperature

As in the measurement of the toner fixing ratio in test (5), the temperature of the fixing roll was varied by 5° C. at a time, and printing was done at each temperature. Hot-offset temperature denotes the temperature at which the toner becomes to remain on the fixing roll to generate soil. A higher the hot-offset temperature is, a higher a hot-offset resistance is, whereby the toner having a higher hot-offset temperature is superior because the toner can be used in a high-printing speed model printer.

(7) Image Density

Copy papers were set in a commercially available non-magnetic-one-component developing type printer (printing speed: 24 sheet/min machine), and the toner for developing electrostatic latent images was put in a developing device of the printer. The toner was left standing over one day and one night under a (N/N) environment of a temperature of 23° C. and a humidity of 50%. Then, a printing was continuously performed at an image density of 5%. And then, a solid image was printed at 10 papers printing and 10,000 papers printing. And, an image density of the printed solid image was measured using a Macbeth type reflective image density measuring apparatus.

(8) Environmental Durability

Copy papers were set in the printer used in (7) and the toner for developing electrostatic latent images was put in a developing device of the printer, and the printer left standing under each environment of a (L/L) environment of a temperature of 10° C. and a humidity of 20%, a (N/N) environment of a temperature of 23° C. and a humidity of 50% and a (H/H) environment of a temperature of 35° C. and a humidity of 80% for one day and one night. Printing was continuously performed at an image density of 5%. And, at every 500 papers printing, a printing of each of plain pattern and solid pattern was performed. And, an image density of each printed paper was measured using the reflective image density measuring apparatus used in (7).

And, during the printing of plain pattern, the printing was stopped, and the toner developed a non-image on the photoconductive member after developing was stripped off and collected by sticking with an adhesive tape (Scotch Mending Tape 810-3-18, trade name, manufactured by Sumitomo 3M Limited). Then, the adhesive tape was stuck on a new sheet of paper to measure whiteness (B) using a whiteness meter (manufactured by Nippon Denshoku Industries Co., Ltd.). At the same time, as a reference, an unused adhesive tape was stuck on the same new sheet of paper to measure whiteness (A).

The environmental durability was evaluated in such a way that a number of papers, which had an image density of the printed solid image of 1.4 or more, and, a difference (A-B) in the whiteness of 1% or less, was examined until 10,000 papers printing. The samples having 10,000 or more in a table show that the aforesaid image quality is kept even after 10,000 papers printing.

### Example 1

81 parts of styrene, 19 parts of N-butylacrylate, 7 parts of carbon black (“#25B”, trade name, manufactured by Mitsubishi Chemical Corporation), 1 parts of negative charge control resin (containing 2% of sulfonic acid functional group, “FCA S748”, trade name, manufactured by FUJIKURA KASEI CO., LTD.), 0.8 parts of divinylbenzene, 0.25 parts of polymethacrylate ester macromonomer (“AA6”, trade name, manufactured by Toagosei CO., LTD.), 0.8 parts of 2,2,4,6,6-pentamethylheptane-4-thiol and 10 parts of dipentaerythritol hexamyristate (an acid value: 0.5 mgKOH/g, a hydroxy value: 0.9 mgKOH/g) were dispersed using a bead mil at room temperature to prepare a polymerizable monomer composition.

Separately, an aqueous solution containing 6.6 parts of sodium hydroxide dissolved in 50 parts of ion-exchanged water was gradually added to an aqueous solution containing 10.8 parts of magnesium chloride dissolved in 250 parts of ion-exchanged water, with stirring, to prepare a colloidal dispersion of magnesium hydroxide. The preparation of the dispersion was performed under a nitrogen gas atmosphere of 23° C.

And, 2 parts of methyl methacrylate and 65 parts of water were mixed to obtain an aqueous dispersion of polymerizable monomer for shell.

The polymerizable monomer composition obtained above was added to the colloidal dispersion of magnesium hydroxide obtained above, and the mixture was stirred until droplets stabilized. After the droplets stabilized, 3 parts of dimethyl 2,2′-azobis (2-methylpropionate) (“V601”, trade name, manufactured by Wako Pure Chemical Industries, Ltd.,) was added to the mixture, and then the mixture was stirred at 15,000 rpm under shearing force using a Ebara Milder (“MDN303V”, trade name, manufactured by Ebara Corporation) for 10 minutes to form droplets of the polymerizable monomer composition. The above preparations were performed under a nitrogen gas atmosphere.

The colloidal dispersion of magnesium hydroxide in which the droplets of the polymerizable monomer composition were dispersed was charged into a reactor equipped with an agitating blade, and heated to 90° C. to initiate a polymerization reaction. At the time when the conversion of the monomer into a polymer reached almost 100%, the aqueous dispersion of the polymerizable monomer for shell and 0.3 parts of water-soluble polymerization initiator (“VA-086”, trade name, manufactured by Wako Pure Chemical Industries, Ltd.,) (2,2′-azobis-(2-methyl-N(2-hydroxyethyl)propionamide)) dissolved in 20 parts of ion-exchanged water were charged into the reactor. The polymerization reaction was continued for 4 hours under a temperature controlled at 90° C. After the polymerization reaction, the dispersion was cooled to obtain an aqueous dispersion of colored resin particles.

While stirring the aqueous dispersion of colored resin particles thus prepared at a room temperature, the pH of the system was adjusted to 5 or lower using sulfuric acid to be subjected to acid washing (25° C., 10 minutes). After the aqueous dispersion was filtered to separate water, 500 parts of ion-exchanged water was newly added thereto to form a slurry again to subject to water washing. Thereafter, the dehydration and water washing were repeatedly performed several times at a room temperature, and solids contained in the solution was separated by filtration and dried at 40° C. for two days and two nights using a dryer to prepare dried colored resin particles. The colored resin particles thus obtained had a volume average particle diameter (Dv) of 6.4 μm, a particle diameter distribution (Dv/Dp) of 1.21 and an average circularity of 0.980.

To 100 parts of the colored resin particles obtained above, 0.5 parts of silica having a degree of hydrophobic property of 65% and a volume average particle diameter of 12 nm and 2 parts of silica having a volume average particle diameter of 50 nm were added and mixed for 10 minutes at 1, 400 rpm using HENSCHEL MIXER to prepare toner for developing electrostatic latent images. Property of the toner and image quality of a printed image developed using the toner were evaluated according to the above-mentioned manner. The results were shown in table 1.

### Example 2

In the same way as the preparation of Example 1, except that 89 parts of styrene, 11 parts of N-butylacrylate, 7 parts of carbon black (“#25B”, trade name, manufactured by Mitsubishi Chemical Corporation), 1 parts of negative charge control resin (containing 2% of sulfonic acid functional group, “FCA S748”, trade name, manufactured by FUJIKURA KASEI CO., LTD.), 0.8 parts of divinylbenzene, 0.25 parts of polymethacrylate ester macromonomer (“AA6”, trade name, manufactured by Toagosei CO., LTD.), 0.8 parts of 2,2,4,6,6-pentamethylheptane-4-thiol and 10 parts of dipentaerythritol hexamyristate (an acid value: 0.5 mgKOH/g, a hydroxy value: 0.9 mgKOH/g) were used to prepare a polymerizable monomer composition, toner for developing electrostatic latent images was obtained. Property of the toner and image quality of a printed image developed using the toner were evaluated as with Example 1. The results were shown in table 1.

### Comparative Example 1

To 100 parts of negative charge control resin (containing 7% of sulfonic acid functional group, “FCA S626N”, trade name, manufactured by FUJIKURA KASEI CO., LTD.), 24 parts of toluene and 6 parts of methyl ethyl ketone were dispersed, and then the mixture was kneaded by rolls under cooling. After the negative charge control resin was winded on the roll, 100 parts of carbon black (“#25B”, trade name, manufactured by Mitsubishi Chemical Corporation) and 40 parts of hydrophobicitizing-treated silica particles (“RX-50”, trade name, manufactured by Nippon Aerosil co., ltd.) having a primary particle diameter of 40 nm was gradually added and kneaded for 40 minutes to prepare a charge control resin compound. During this period, the clearance between the rolls was initially 1 mm, broadened gradually, to finally to 3 mm, and an organic solvent (a solvent mixture of toluene/methyl ethyl ketone=4/1) was added occasionally according to mixing and kneading condition of the charge control resin composition.

90 parts of styrene, 10 parts of butyl acrylate, 14.4 parts of the negative charge control resin compound obtained above, 3 parts of t-dodecyl mercaptan and 10 parts of pentaerythritol tetrastearate were stirred and mixed to be dispersed uniformly to prepare a polymerizable monomer composition.

And, 2 parts of methyl methacrylate and 100 parts of water were mixed to prepare an aqueous dispersion of polymerizable monomer for shell.

Separately, an aqueous solution containing 6.9 parts of sodium hydroxide dissolved in 50 parts of ion-exchanged water was gradually added to an aqueous solution containing 9.8 parts of magnesium chloride dissolved in 250 parts of ion-exchanged water, with stirring, to prepare a colloidal dispersion of magnesium hydroxide.

The polymerizable monomer composition obtained above was added to the colloidal dispersion of magnesium hydroxide obtained above, and the mixture was stirred until droplets stabilized. After the droplets stabilized, 6 parts of polymerization initiator of t-butylperoxy-2-ethylhexanoate (“PERBUTYL O”, trade name, manufactured by NOF CORPORATION) was added to the mixture, and then the mixture was stirred at 15,000 rpm under shearing force using a Ebara Milder for 30 minutes to granulate droplets of the polymerizable monomer composition. An aqueous dispersion of the granulated polymerizable monomer composition was charged into a reactor equipped with an agitating blade, and heated to 90° C. to initiate a polymerization reaction. At the time when the conversion of the monomer into a polymer reached almost 100%, the aqueous dispersion of the polymerizable monomer for shell and 0.2 parts of 2,2′-azobis-(2-methyl-N-(2-hydroxyethyl)-propionamide) (“VA-086”, trade name, manufactured by Wako Pure Chemical Industries, Ltd.,) dissolved in 65 parts of distilled water were charged into the reactor. After the polymerization reaction was further continued for 8 hours, the reaction was stopped to obtain an aqueous dispersion of colored resin particles. Thereinafter, in the same way as Production Example 1, toner for developing electrostatic latent images was obtained. Property of the toner and image quality of a printed image developed using the toner were evaluated according to the above-mentioned manner. The results were shown in table 2.

### Comparative Example 2

A natural gas based Fischer-Tropsch wax (“FT-100”, trade name, manufactured by Shell MDS) having an endothermic peak temperature of 93° C., a weight average molecular weight of 1,000 and a number average molecular weight of 670 was purified by a fractional crystallization method to prepare a wax (a parting agent) having an endothermic peak temperature of 82° C. and a number average molecular weight of 860.

As a parting agent, 10 parts of the wax obtained above was wet-milled in 90 parts of styrene using a media type wet mill to prepare a dispersion of styrene monomer parting agent in which the parting agent was uniformly dispersed. 20 parts of the dispersion of parting agent (containing 18 parts of styrene), 62.5 parts of styrene, 19.5 parts of n-butylacrylate, 7 parts of carbon black (“#25B”, trade name, manufactured by Mitsubishi Chemical Corporation) having a primary particle diameter of 40 nm, 0.5 parts of charge control agent (“Spilon Black TRH”, trade name, manufactured by HODOGAYA CHEMICAL CO., LTD.), 0.3 parts of polymethacrylate ester macromonomer (“AA6”, trade name, manufactured by Toagosei CO., LTD.) having a grass transition temperature of 94° C., 0.6 parts of divinylbenzene and 1.2 parts of t-dodecyl mercaptan were stirred and mixed using a conventionally used stirrer for uniform dispersion to obtain a polymerizable monomer composition (a compound liquid).

Separately, an aqueous solution containing 5.8 parts of sodium hydroxide dissolved in 50 parts of ion-exchanged water was gradually added to an aqueous solution containing 9.5 parts of magnesium chloride dissolved in 250 parts of ion-exchanged water, with stirring, to prepare a colloidal dispersion of magnesium hydroxide.

And, 2 parts of methyl methacrylate and 100 parts of water were mixed to prepare an aqueous dispersion of polymerizable monomer for shell.

The aqueous dispersion of polymerizable monomer for shell and 0.2 parts of a water-soluble polymerization initiator of 2,2′-azobis(2-methyl-N-(2-hydroxyethyl) propionamide) dissolved in 65 parts of distilled water were charged into a reactor. After the polymerization reaction was continued for 4 hours, the reaction was stopped to obtain an aqueous dispersion of colored resin particles. Thereinafter, in the same way as Production Example 1, toner for developing electrostatic latent images was obtained. Property of the toner and image quality of a printed image developed using the toner were evaluated according to the above-mentioned manner. The results were shown in table 2.

### Comparative Example 3

650 parts of ion-exchanged water and 500 parts of 0.1 mol/little-Na₃PO₄ aqueous solution were charged into a 2 little four-separable flask equipped with a high-speed stirrer of TK homomixer (manufactured by Tokushu Kika Kogyo), and the mixture was heated to 70° C. a while adjusting a rotating speed of the high-speed stirrer at 12,000 rpm. Then, 70 parts of 1.0 mol/little-CaCl₂ aqueous solution was gradually added to prepare an aqueous continuous phase (an aqueous medium) containing fine hardly water-soluble dispersion stabilizer Ca₃(PO₄).

As a dispersion, a mixture comprising 39 parts of styrene, 11 parts of n-butylacrylate, 10 parts of carbon black (“#25”, trade name, manufactured by Mitsubishi Chemical Corporation) and 2 parts of negative charge control agent (azo iron complex) was dispersed using an atoriter (manufactured by Mitsui Miike Kako Co. Ltd.) for 3 hours. Then, to the dispersed mixture, 4 parts of saturated polyester resin (a peak molecular weight: 4500, Tg: 70° C.), 50 parts of long chain branched low molecular weight polyalkylene wax (a weight average molecular weight: 16000, a number average molecular weight: 1600, a peak molecular weight: 4000, a maximum endothermic peak temperature: 70° C.) and 10 parts of 2,2′-azobis(2,4-dimethyl valeronitrile) were added, and the mixture was heated to 70° C. to prepare a polymerizable monomer composition.

Then, the polymerizable monomer composition was added to the aqueous medium, and the resultant mixture was stirred for 15 minutes while maintaining a rotating speed of the high-speed stirrer to 12,000 rpm at a liquid temperature of 70° C. under a nitrogen gas atmosphere to be granulated. Then, the stirrer was exchanged for a propeller stirring blade and then the mixture was maintained at 70° C. for 10 hours while stirring at 50 rpm to obtain a suspension.

Then, the suspension was cooled, and a mixture of 88 parts of styrene, 12 parts of n-butylacrylate, 1 parts of unsaturated polyester resin (a peak molecular weight: 5200, Tg: 59° C.) and 5 parts of 2,2′-azobis(2,4-dimethyl valeronitrile) was dropped to the suspension. And, the suspension was heated to 70° C. again and maintained for 10 hours.

In addition, the pressure of the flask was reduced using a vacuum pump down to about 50 kPa and the aqueous medium was maintained at 80° C., and then distillation was performed for 10 hours. Then, the suspension was cooled and diluted hydrochloric acid was added to the suspension to remove the dispersion stabilizer and to filter colored resin particles. And, water washing was subjected to the suspension several times. And, the colored resin particles were charged into a cylindrical container having a jacket. Then, the cylindrical container was rotated with 50° C. hot water being passed into the jacket, and the pressure of the container was reduced down to about 10 kPa and the inside of the container was dried for 10 hours to obtain dry colored resin particles. Thereinafter, in the same way as Production Example 1, toner for developing electrostatic latent images was obtained. Property of the toner and image quality of a printed image developed using the toner were evaluated according to the above-mentioned manner. The results were shown in table 2.

TABLE 1

| | Ex. 1 | Ex. 2 |
|---|---|---|
| <Property of Colored Resin Particle> | | |
| Volume average particle diameter (μm) | 6.4 | 6.5 |
| Particle diameter distribution (Dv/Dp) | 1.21 | 1.20 |
| Average circularity | 0.980 | 0.970 |
| <Property of Toner> | | |
| Shear viscosity η1 (Pa · s) | 4,500 | 6,800 |
| Shear viscosity η2 (Pa · s) | 500 | 1,000 |
| η1/η2 | 9.0 | 6.8 |
| Content A of volatilized component (ppm) | 32 | 17 |
| Content B of volatilized component (ppm) | 40 | 35 |
| A + B | 72 | 52 |
| A/B | 0.8 | 0.5 |
| Amount of insoluble component in THF | 75 | 58 |
| (wt %) | | |
| <Evaluation of printed image> | | |
| Fixing rate (%) | 98 | 96 |
| Hot-offset temperature (° C.) | 200 | 200 |
| Image Density | | |
| Starting | 1.47 | 1.42 |
| After 10,000 papers printing | 1.41 | 1.37 |
| Environmental Durability | | |
| L/L | 10,000 or | 1,000 or |
| | more | more |
| N/N | 10,000 or | 9,000 |
| | more | |
| H/H | 8,000 | 7,500 |

TABLE 2

| | Com. | Com. | Com. |
|---|---|---|---|
| | Ex. 1 | Ex. 2 | Ex. 3 |
| <Property of Colored Resin | | | |
| Particle> | | | |
| Volume average particle diameter | 7.3 | 7.1 | 6.7 |
| (μm) | | | |
| Particle diameter distribution | 1.2 | 1.19 | 1.22 |
| (Dv/Dp) | | | |
| Average circularity | 0.980 | 0.965 | 0.980 |
| <Property of Toner> | | | |
| Shear viscosity η1 (Pa · s) | 3,100 | 8,700 | 11,000 |
| Shear viscosity η2 (Pa · s) | 250 | 1,050 | 1,300 |
| η1/η2 | 12.4 | 8.3 | 8.5 |
| Content A of volatilized | 180 | 70 | 85 |
| component (ppm) | | | |
| Content B of volatilized | 260 | 220 | 71 |
| component (ppm) | | | |
| A + B | 440 | 290 | 156 |
| A/B | 0.7 | 0.3 | 1.2 |
| Amount of insoluble component in | 22 | 93 | 60 |
| THF (wt %) | | | |
| <Evaluation of printed image> | | | |
| Fixing rate(%) | 100 | 83 | 75 |
| Hot-offset temperature | 175 | 200 | 190 |
| Image Density | | | |
| Starting | 1.41 | 1.45 | 1.19 |
| After 10,000 papers printing | 1.24 | 1.16 | 1.09 |
| Environmental Durability | | | |
| L/L | 9,000 | 9,000 | 8,000 |
| N/N | 7,500 | 7,000 | 7,000 |
| H/H | 6,000 | 6,000 | 6,500 |

The results of the evaluation of the toners for developing electrostatic latent images shown in the tables 1 and 2 show the following facts.

The toners for developing electrostatic latent images of the Comparative Production Examples 1 to 3, in which shear viscosities η1 and η2 of the toners were outside of the scope of the present invention, have low image density after 10,000 papers printing and show insufficient environmental durability. In addition, the toners for developing electrostatic latent images of the Comparative Production Examples 1 and 3 has low hot-offset temperature and the toners for developing electrostatic latent images of the Comparative Production Examples 2 and 3 has low fixing rate.

On the contrary, by using the toners of the Examples 1 to 2 according to the present invention, hot-offset is hardly occurred. And, the toners have high fixing rate and excellent environmental durability.

What is claimed is:

1. A toner for developing electrostatic latent images comprising a colored resin particle containing a binder resin, a colorant, a charge control agent and a parting agent, having the following properties:
(1) said colored resin particle has a volume average particle diameter (Dv) in the range of 4 to 9 μm;
(2) said colored resin particle has an average circularity in the range of 0.93 to 0.995;
(3) said toner has a share viscosity (η1) at a temperature of 130° and a shear rate of 10/s in the range of 3,500 to 8,000 Pa·s;
(4) said toner has a share viscosity (η2) at a temperature of 130° and a shear rate of 500/s in the range of 300 to 1,300 Pa·s;
(5) said toner has a content A of a component having a volatilization temperature of 130° C. or lower of 100 ppm or smaller;
(6) said toner has a content B of a component having a volatilization temperature of higher than 130° C. to 180° C. of 100 ppm or smaller;
(7) said toner has a total of the content A and the content B of 150 ppm or smaller; and
(8) said toner has a ratio of the content A to the content B of 1.0 or smaller.

2. The toner for developing electrostatic latent images according to claim 1,
wherein a ratio of the η1 to η2 (η1/η2) is 3 to 10.

3. The toner for developing electrostatic latent images according to claim 1,
wherein an amount of insoluble component in tetrahydrofran is 50 to 95% by weight.

4. The toner for developing electrostatic latent images according to claim 1,
wherein the charge control agent is a charge control resin.

5. The toner for developing electrostatic latent images according to claim 4,
wherein the charge control resin has a glass transition temperature in the range of 40 to 80° C.

6. The toner for developing electrostatic latent images according to claim 1,
wherein the parting agent is a multifunctional ester compound having a hydroxyl value of 5 mgKOH/g or less.

7. The toner for developing electrostatic latent images according to claim 1,
wherein the parting agent is a multifunctional ester compound having an acid value of 1 mgKOH/g or less.

8. The toner for developing electrostatic latent images according to claim 1,
wherein the parting agent is a multifunctional ester compound having a molecular weight of 1,000 or more.

9. The toner for developing electrostatic latent images according to claim 1,
wherein the parting agent is a multifunctional ester compound soluble in 100 parts by weight of styrene at 25° C. in an amount of 5 parts by weight or more.

10. The toner for electrostatic latent images according to claim 1,
wherein the colored resin particle has an average circularity in the range of 0.95 to 0.995.

11. The toner for electrostatic latent images according to claim 1,
wherein the colored resin particle has a volume average particle diameter (Dv) in the range of 4 to 7 μm.

12. The toner for electrostatic latent images according to claim 1,
wherein the colored resin particle has a ratio (Dv/Dp) of a volume average particle diameter (Dv) to a number average particle diameter (Dp) in the range of 1.0 to 1.3.

13. The toner for developing electrostatic latent images according to claim 1,
wherein the binder resin is a polymer produced by a polymerization of a polymerizable monomer containing monovinylmonomer and crosslinkable monomer, in which an addition amount of said crosslinkable monomer is 0.1 to 2 parts by weight or less per 100 parts by weight of said monovinyl monomer.

14. The toner for developing electrostatic latent images according to claim 13,
wherein a molecular weight modifier is employed at the polymerization of said polymerization monomer, in which an addition amount of said molecular weight modifier is 0.1 to 5 parts by weight per 100 parts by weight of the polymerization monomer.

15. The toner for developing electrostatic latent images according to claim 14,
wherein the molecular weight modifier is 2,2,4,6,6-pentamethylheptane-4-thiol.

16. The toner for developing electrostatic latent images according to claim 1 further containing an external additive,
wherein a content of the external additive is 0.1 to 6 parts per 100 parts by weight of the colored resin particle.

17. The toner for developing electrostatic latent images according to claim 16,
wherein the external additive is a hydrophobicitizing-treated particle.

18. The toner for developing electrostatic latent images according to claim 16,
wherein the external additive is a hydrophobicitizing-treated silica particle.

19. The toner for developing electrostatic latent images according to claim 1,
wherein said colored resin particle is produced by a polymerization reaction.
